(19) United States
(12) Patent Application Publication
(10) Pub. No.: US 2008/0045437 A1
(43) Pub. Date: Feb. 21, 2008

(54) Soap bar with hidden indicia

(76) Inventor: Barbara Pfeifer, Princeton Junction, NJ (US)

Correspondence Address: DAVID ODELL SIMMONS, 7637 PARKVIEW CIRCLE, AUSTIN, TX, 78731, US

(21) Appl. No.: 11/893,466

(22) Filed: Aug. 16, 2007

Related U.S. Application Data
(63) Continuation of application No. 11/372,701, filed on Mar. 10, 2006.

(51) Int. Cl. C11D 17/06

(52) U.S. Cl. 510/449

(57) ABSTRACT

A soap bar comprises a soap bar body made from a first soap composition. The soap bar body includes a ridge defining a perimeter of the face such that the face and the ridge jointly define a recess in the soap bar body. The soap bar body further includes indicia that are at least one of within the face and extending above the face therefrom. The indicia are made from the first soap composition and the first soap composition is of a first color. The soap bar further comprises a layer of a second soap composition within the recess and covering the indicia such that the indicia are visually hidden under the layer of the second soap composition. The second soap composition is of a second color different than the first color first color.

### CROSS REFERENCE TO RELATED APPLICATIONS

This patent application is a continuation-in-part of U.S. non-provisional utility patent application having Ser. No. 11/372,701; filed Mar. 10, 2006; entitled “Bar Soap With Hidden Message”; and having a common applicant herewith, and which is being incorporated herein in its entirety by reference.

### FIELD OF THE DISCLOSURE

This present invention relates generally to soap bars and, more particularly, to soap bars with indicia hidden therein.

### BACKGROUND

Soap bars are well known to the art. Besides functioning primarily as cleansers, soap bars generally are provided in aesthetically pleasing forms. Such soap bars typically include perfumes and fragrance and usually are provided in attractive packaging. Often, soap bars have aesthetic designs formed on a surface so as to render them decorative or aesthetically pleasing. Moreover, the soap bars often serve as advertising vehicles for their manufacturers, and the manufacturer's name and/or trademarks generally are printed directly on the soap bar itself. That is, most commonly, the brand name of the soap bar and/or manufacturer is molded or stamped onto the soap bar's surface. This molding or stamping of the company or product name into the product serves as a source of company and product advertising at least until use of the soap bar under normal bathing or washing conditions wears the name from the surface of the soap bar.

The desire to have a company name or product name affixed to a soap bar is not limited to the manufacturer of the soap bar. For example, large hotel chains provide complimentary soap in their rooms, which typically have the name of the hotel chain stamped or molded into the surface of the soap bar. Other establishments, such as restaurants, casinos and amusement parks have been known to offer such decorated or labeled soap bars for sale in gift shops as premium souvenirs.

U.S. Pat. Nos. 3,432,325, 4,078,482 and 4,297,228 all disclose methods of embossing indicia on soap bars: The conventional methods for labelling soap bars addressed in the above patents all suffer from the same drawbacks. Conventional stamping, embossing or molding results in a superficial decoration formed from the surface of the soap bar, which quickly deteriorates or wastes away as the soap bar is used. Moreover, this type of decoration is limited. The design or lettering is either cut or stamped into the soap bar's surface or consists of raised soap material on the surface of the soap bar. The methods for “decorating” soap bars disclosed in these patents all produce a superficial label, printing or design which is readily visible prior to use of the soap bar and is not concealed by the soap bar in any manner.

Prior art patents have addressed in various manners the desire to provide indicia designs within soap bar. In many prior art embodiments, indicia are provided in a soap bar in a continuously visible manner. In such embodiments, the hidden indicia are encapsulated within a fully or partially transparent soap material with the indicia being formed itself from a soap material or, alternatively, from a non-soap material. Clearly, such soap bars make no attempt at concealing the indicia within the soap bar for the purpose of later discovery by a user of the soap bar.

One attempt to provide a bar of soap bearing a design or printing that remains intact and readable while the soap bar is used is disclosed in U.S. Pat. Nos. 5,869,437 and 6,184,191 to Wolfersberger. The Wolfersberger Patents disclose a transparent cleansing bar having a logo or message printed on a dissolvable polymer material embedded at approximately the mid-point of the soap bar. The Wolfersberger Patents fail to conceal messages within the soap bar and depend upon providing soap bars that are formulated to be transparent so that a printed sheet within the soap bar can be read without distortion of the printed message thereon. In addition to requiring that the soap bar itself be transparent, the Wolfersberger patents have a number of other drawbacks. Namely, different compositions are required for the design or insert as compared to the surrounding transparent soap material. To provide a soap bar bearing a message that remains intact and readable while the soap bar is used, the message is not composed of soap itself, but rather is provided on a separate polymer film disposed within a transparent soap bar.

Another attempt to provide a bar of soap bearing a design or printing that remains intact and readable while the soap bar is used is disclosed in U.S. Pat. No. 6,689,728 to Diez. Diez concerns a method of preparing a transparent, translucent cleansing bar having one or more visible soap inserts, wherein a transparent soap matrix surrounding the soap bar insert has an increased melting temperature of at least 55° C. As with the Wolfersberger Patents discussed above, the Diez Patent fails to conceal messages within the soap bar and depend upon providing a bar of soap that is formulated to be transparent so that a printed sheet within the soap bar can be read without distortion of the printed message thereon.

Similar to indicia on an exterior surface of a soap bar or within a transparent soap bar, it is in some instances desirable to have indicia hidden within an unused soap bar. Examples of applications for soap bars with indicia hidden therein include, but are not limited to, advertising via a particular indicia, various messages, game clues, instant-win game chances, decoration of the soap bar, and the like. Regardless of the reason, hidden indicia being provided within soap bars serves a means for conveying a message or information to a person using the soap bar.

While some embodiments of prior art soap bars include indicia contained therein that is continuously visible from when the soap bar is new to when it is partially or fully used, other prior art soap bars provide indicia therein that is initially hidden and that becomes visible after use of the soap bar. For example, U.S. Pat. No. 4,081,394 to Bartley discloses a soap bar that comprises an outer shell of soft soap material, an intermediate shell of harder soap material and an inner core of still harder material. The inner core is inscribed with different words (i.e., hidden indicia). The provision of an intermediate harder layer prevents the breaking of the soap bar into small pieces after the outer layer has been used up, as is the case in conventional soap bars. Similarly, the harder inner core remains intact until it, too, is fully used up, which prevents a substantial waste of soap. As is evident from the disclosure of Bartley, the intent is to conceal the hidden indicia until the soap bar is used for a considerable number of uses. The configuration of Bartley's soap bar delays the exposure of the hidden indicia until the inner core is exposed, which is by definition of Bartley's soap bar a considerable period of time relative to the soap bar's entire usage. Such delay is counter to a bar of soap whose intended premise is to expose the hidden message shortly after use so that a user of the soap bar need not become impatient with seeing the indicia.

Therefore, a soap bar with hidden indicia therein, that can be manufactured in a cost-effective manner, and that is configured in a manner such that the hidden indicia becomes available within a short duration of time and/or a small number of uses would be advantageous, desirable and useful.

### SUMMARY OF THE DISCLOSURE

It would be desirable to have a soap bar with hidden indicia therein within, which become visible only after the soap bar is used and that would remain visible long after the indicia on the soap bar's outer surface had worn off. Examples of such hidden indicia include, but are not limited to, inspirational messages, celebratory or historical themed messages, messages that offer a personal secret message such as proposal of marriage, childbirth announcement messages, messages relating to special dates, messages that provide a fortune, coded messages, messages relating words of wisdom, messages relating to a particular sentiment, messages providing a lucky numbers, messages providing trivia, messages promoting a branded tag-line or slogan, and the like. Alternatively, the hidden indicia can be the name of a person, pet, product, etc. Such a soap bar has several attractive purposes such as building the curiosity of its users to discover the hidden message(s), which leads to further use of the soap bar and which expands the overall functionality of the soap bar as a vehicle or medium for personalized message delivery. With respect to manufacturers and venders, such a soap bar serves as an advertising medium for corporate identity information (e.g., a brand name) thereby providing increased visibility long after such corporate identity information inscribed in an exterior surface of the soap bar washes away.

In one embodiment of the present invention, a method of forming a soap bar comprises a plurality of operations. An operation is performed for forming a soap bar body from a first soap composition. In conjunction with forming the soap bar body or after forming the soap bar body, an operation is performed for forming indicia integral with a face of the soap bar body. Thereafter, an operation is performed for forming a layer of a second soap composition on the soap bar body over the indicia such that the indicia are visually hidden under the layer of second soap composition. The second soap composition visually contrasts the first soap composition.

In another embodiment of the present invention, a soap bar comprises a soap bar body made from a first soap composition and a layer of a second soap composition. The soap bar body includes indicia integral with a face thereof and the indicia are made from the first soap composition. The layer of the second soap composition is formed on the soap bar body over the face and the indicia such that the indicia are visually hidden under the layer of the second soap composition. The second configuration soap composition visually contrasts the first soap composition.

In another embodiment of the present invention, a soap bar comprises a soap bar body made from a first soap composition. The soap bar body includes a ridge defining a perimeter of the face such that the face and the ridge jointly define a recess in the soap bar body. The soap bar body further includes indicia that are at least one of within the face and extending above the face therefrom. The indicia are made from the first soap composition and the first soap composition is of a first color. The soap bar further comprises a layer of a second soap composition within the recess and covering the indicia such that the indicia are visually hidden under the layer of the second soap composition. The second soap composition is of a second color different than the first color first color.

These and other objects, embodiments, advantages and/or distinctions of the present invention will become readily apparent upon further review of the following specification, associated drawings and appended claims.

### BRIEF DESCRIPTION OF THE DRAWINGS

A more complete understanding of the present invention may be obtained from consideration of the following description in conjunction with the drawings in which:

FIG. 1 is a perspective view of a bar soap with embedded message;

FIG. 2 is a top plan view of the bar soap of FIG. 1;

FIG. 3 is a side view of the bar soap of FIG. 1;

FIG. 4 is an exploded view of the bar soap of FIG. 1;

FIG. 5 is a perspective view of a bar soap with two embedded messages;

FIG. 6 is a top plan view of the bar soap of FIG. 5;

FIG. 7 is a side view of the bar soap of FIG. 5;

FIG. 8 is an exploded view of a bar soap with two embedded messages;

FIGS. 9 and 10 are block diagrams illustrating methods of embossing indicia on a layer of bar soap material;

FIG. 11 is a perspective view showing an embodiment of an as-new soap bar (i.e., bar soap) in accordance with the present invention;

FIG. 12A is a cross sectional view taken along the line 12A-12A in FIG. 11;

FIG. 12B is a perspective view showing the soap bar body of FIG. 11;

FIG. 13 is a perspective view showing the soap bar of FIG. 11 in a first partially used condition, whereby a first hidden message is revealed;

FIG. 14 is a perspective view showing the soap bar of FIG. 11 in a second partially used condition, whereby a second hidden message is revealed and the first hidden message is fully washed away; and

FIG. 15 is a flowchart showing a method for producing a soap bar in accordance with the present invention.

### DETAILED DESCRIPTION OF THE DRAWING FIGURES

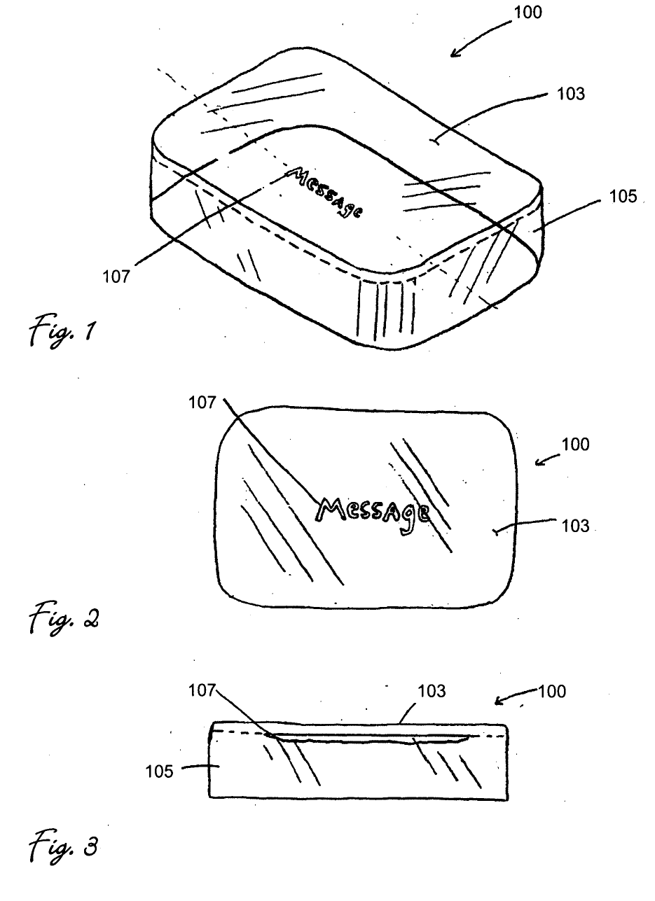

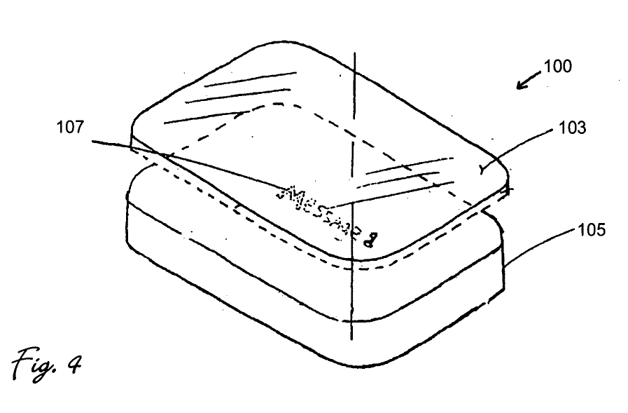

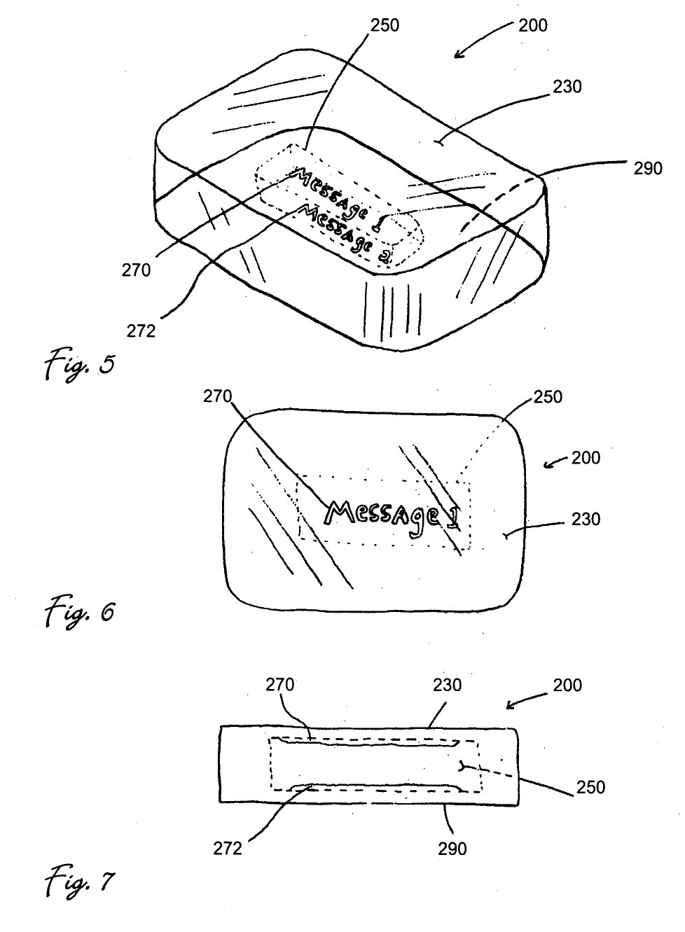

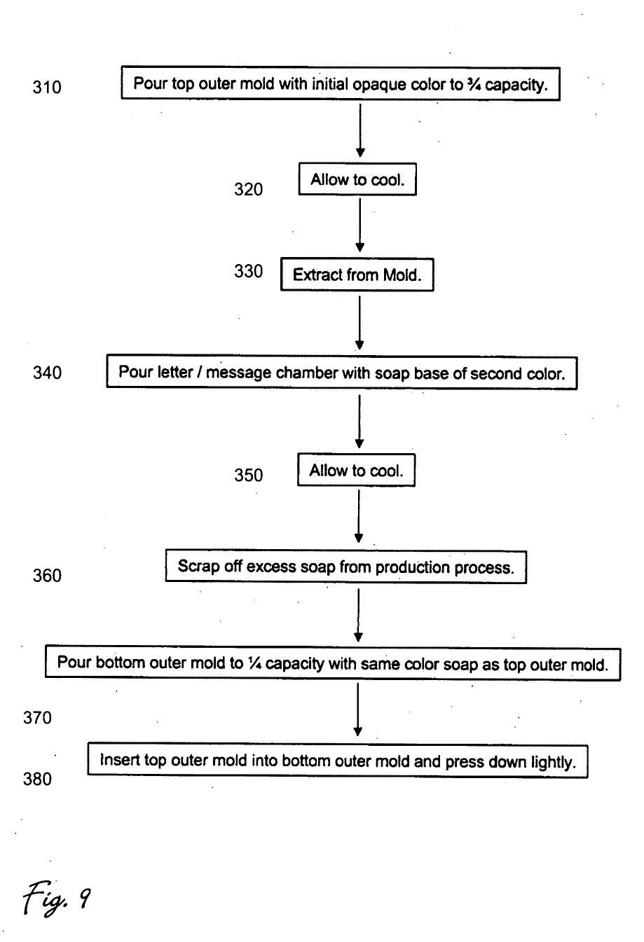

Referring to FIGS. 1-10, a first embodiment of a bar soap 100 (i.e., soap bar) and associated method of manufacture is disclosed. The soap bar 100 has a hidden message(s) or design(s) embedded within the soap bar. Indicia are defined herein to include any image, text, message(s), design(s) and the like. The hidden message (i.e., indicia) becomes viewable only after a sufficient amount of the surface of the bar is worn from use. The bar soap 100 is not transparent but rather opaque to initially conceal the message within the bar soap. Prior to use of the soap, the message, which is itself composed of soap, is not visible and only after the surface of the bar deteriorates or wastes away due to use, does the message become viewable. The message can be embedded off-center in a layer of the cleansing bar at a depth such that, once exposed, it dissolves with regular use of the bar.

The method of manufacture disclosed in reference to FIGS. 1-10 provides for making the aforementioned soap bar 100 with an embedded message or design therein using a two-step, three-pour process. In the first step the top outer mold is poured with the initial opaque color to approximately ¾ of capacity and allowed to cool. Once cooled this soap can be extracted and allowed to further cool overnight. The impressed message or design chamber in the top outer mold is then poured with a mica tint soap base of a second color and allowed to cool. Excess soap from the production process can now be scraped off. The third pour for creating the bottom outer mold is now made. Namely, the mold is filled approximately ¼ with the same color soap as the top outer mold and the top outer mold is then inserted into the bottom outer mold and pressed down lightly. If necessary, the mold can then be topped off with additional soap if the mold has not been completely filled.

The actual amount that the mold is filled will depend upon the particular mold design and style as well as the number of message layers and how quickly the message is to appear. The positioning of the message(s) with in the bar and thus the corresponding number of uses required before the message is revealed can be adjusted to suit the application. For example, a prize or lottery application should take longer to reveal itself while a personal message such as “I Love You” or “Will You Marry Me” would be revealed sooner. Typically no more than one third of the volume of the bar soap should have to be dissolved by use before the hidden message(s) are revealed. When used to reveal a progressive message or image, the bar soap can be used as a motivational tool in getting children to wash their hands. Where more than one message is contained within the bar soap, this would be noted on the packaging or can be a part of the message i.e. “more to come” or . . . etc.

The following description will enable one skilled in the art to make and use the invention, and describes several embodiments, adaptations, variations, alternatives and uses of the invention, including what we presently believe is the best mode of carrying out the invention. It should be understood that any feature described in one embodiment or arrangement can be equally applied to any other embodiment or arrangement without departing from the spirit of the present invention.

Referring to FIG. 1 there is shown a perspective view of a bar soap bearing a concealed message or design made in accordance with the principles of the present invention. Again referring to FIG. 1 in conjunction with FIGS. 2, 3 and 4, it can be seen that bar soap 100 has an elongated soap bar configuration. It will be appreciated, however, that bar 100 can be of any desired configuration. That is, it can be formed or molded having a round or disc-shaped configuration or any other decorative or aesthetically pleasing shape, size or design such as a ball, flower, shell or so on, without departing from the scope of the invention. It also will be appreciated that bar soap 100, whatever the configuration, can be referred to as a soap bar.

Bar soap 100 includes an imprinted layer 105. Layer 105 bears imprinted or engraved message 107, which, in the figures, for illustration only, is shown as the word “message.” Imprinted layer 105 is positioned within bar soap 100 such that message 107 is located anywhere between 1/18 and ⅓ below the bar's surface 103, allowing the messages to become visible after the first several uses of the bar soap, preferably between five to thirty uses. Accordingly, message 107 is preferably close to the bar's top surface 103, yet still concealed. Message 107 can be a variety of indicia including but not limited to any printed words, design, logo, picture, insignia, advertisement, trademark, service mark, business name, quote, etc. While shown in the drawing for purpose of illustration only, message 107 is not visible through bar soap 100 and only becomes visible as bar soap 100 is used as discussed further below.

Message 107 can have several applications including, but not limited to, brand promotion, predestination applications, proposal, newly expecting announcement, milestone markers, seasonal greeting, humor, etc. It also will be appreciated that the printed matter, referred to hereinafter as “message” for ease and clarity of description, can be engraved, embossed or drawn into layer 105 in any desired color or pattern. The resulting message is not viewable or distinguishable through any surface of bar soap 100 prior to use and only becomes apparent after the soap is used and the surface layer 103 of bar soap 100 has wasted away.

When bar soap 100 is used such that the surface of imprinted layer 105 is exposed, the message is visible and/or readable to the user. Because message 107 is imprinted in the bar soap it will dissolves over time with further use of the bar soap. In an alternative embodiment, several additional imprinted layers in addition to layer 105 can be included within bar soap 100 such that once one message (associated with one layer) dissolves, another message (associated with another layer) will become visible. Upon normal use, the concealed message becomes visible after anywhere from five to thirty uses of the bar soap. The layer 105 can be any predetermined or random shape or size sufficient to hold the desired message that is to be concealed within the soap for later discovery by the user.

One of skill in the art should realize that layer 105 does not necessarily need to have a message imprinted on the top side as shown in FIG. 1, nor is it limited to only one imprinted surface. Alternatively, layer 105 can comprise one or more imprinted surfaces, whether on the top, bottom or side surfaces. According to such an arrangement, the bar soap could have several messages embedded therein becoming visible at different times and on different sides of the bar.

Referring to FIG. 1, it can be seem that during manufacture of bar soap 100 a separate imprinted soap layer 105 may be constructed in accordance with the steps provided in FIG. 9. Layer 105 includes at least one message 107 embossed into its surface. At this stage, layer 105 may itself resemble a bar soap with an imprinted outer surface. The imprinted outer surface may be raised off of the surface of the layer 105 or impressed within the layer 105, depending on the particular mold or embossing technique used during manufacture. Layer 105 is preferably a dissolvable soap and can be opaque or translucent.

One process of making bar soap 100, in accordance with the present invention is illustrated in FIG. 9. In the first step 310 the top outer mold is poured with the initial opaque color to three quarters of capacity and allowed to cool 320. Once cooled this soap can be extracted 330 and allowed to further cool overnight. The impressed message or design chamber in the top outer mold is then poured 340 with a mica tint soap base of a second color and allowed to cool 350. Excess soap from the production process can now be scraped off 360. The third pour for creating the bottom outer mold is now made. Namely, in step 370 the mold is filled one quarter with the same color soap as the top outer mold and the top outer mold is then inserted into the bottom outer mold and pressed down lightly in step 380. If necessary, the mold can then be topped off with additional soap if the mold has not been completely filled.

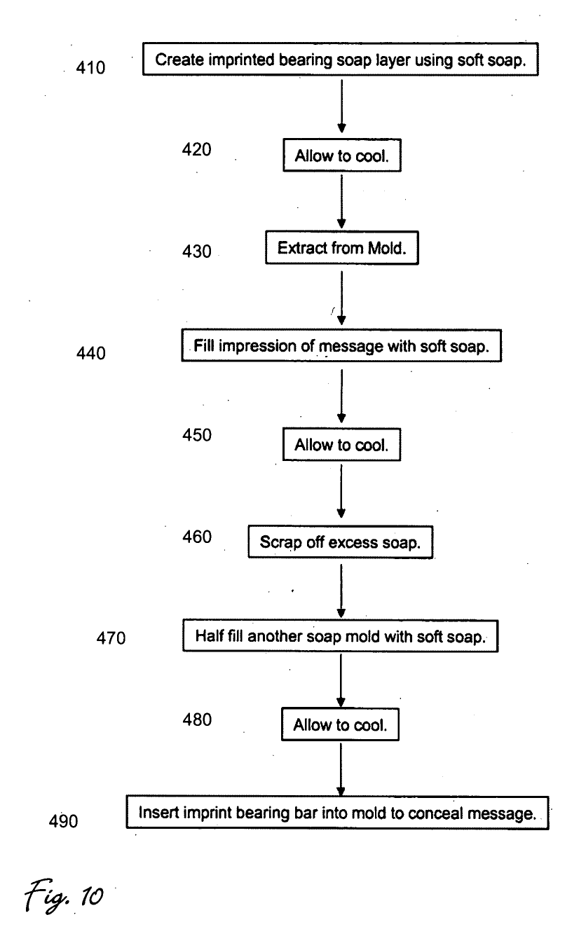

Another process of making bar soap 100 is illustrated in FIG. 10. First, in step 410 a mold bearing an impression of the message or design to be imprinted within the soap is filled with soap that has been liquefied at high temperatures. As the mold is cooled the soap is allowed to solidify in step 420. Once the soap has been sufficiently cooled, the resultant hardened soap with imprinted layer thereon is extracted from the mold in step 430. Next, the impression of the message (message cavity) left in the soap is filled with a soap (preferably of a different color or clear) that has been liquefied at high temperatures in step 440. This soap is then allowed to cool allowing it to solidify in step 450. Once cooled, in step 460 excess soap on the surface of the bar can be scraped clean. Next, a mold configured to join with the imprint bearing bar is formed. This mold is filled with opaque soap liquefied at high temperatures in step 470. As the liquefied soap begins to cool in step 480 the imprint bearing bar is inserted face down into the mold and joined with the addition soap in step 490. This hides the message from view. Pressure can be applied to the imprinted bar to aid this bonding processing. One of ordinary skill in the art should realize that the above described process is a three pour process: first pouring and solidifying a first quantity soap creating a soap layer containing an impression of message; then filling the message cavity by pouring and solidifying a second quantity of soap; and finally, pouring and solidifying a third quantity of soap to cover and conceal the message from view. The second quantity of the soap poured is preferably clear or of a different color than the first and third portions, allowing the imprinted message to become readable as the first and third layers of the soap waste away during use.

An automated system of making bar soap 100 in accordance with the present invention begins with imprinting a layer of soap 105 with a desired message, logo or design 107. Imprinted layer 105 is itself a bar soap, however is configured to join with an additional layer or layers of soap or fit within a larger soap mold that is scheduled for filling. Layer 105 can be formulated in relatively solid form (e.g. solid enough to be handled in manufacturing). In this manner the message may be made, decorated with paints or other colorants, and dropped into the soap mold during manufacture.

Next, a batch of soap product to form the surface bar 103 is prepared. Accordingly, a mold is placed onto a moving conveyor belt. The mold is designed to produce any desired configuration of soap cake, as discussed above. The mold can be a polyvinyl clamshell mold or a multi-cavity tray made from a silicone compound. The molds travel down the conveyer and trigger a conventional filling mechanism. A piston liquid filler then dispenses a small, predetermined amount of liquid hot soap into the mold to partially or half fill the mold. The mold then travels through a cooling tunnel and exits at the opposite end of the conveyor line substantially harder than it entered. The bar is then placed on a return conveyor, which returns it to the front of the line. The partially filled mold is then placed onto the conveyor for a second pass. If the imprinted layer 105 discussed above is provided on a carrier, it is first removed or pulled off the carrier. The imprinted layer 105 is placed onto the cooled surface bar 103 in the mold, generally by hand, and lightly rubbed down. The imprinted layer is set such that the message or messages 107 thereon will be covered by, yet sufficiently close to, the surface 103 of the final bar product.

This process produces a bar soap 100, which has one or more messages 107 concealed within the bar. According to a preferred embodiment, message 107 is located a predetermined distance beneath the surface 103 of bar soap 100 and is approximately between one eighteenth and one third the distance from the bar soap's 100 surface 103. Any message or design 107 imprinted on layer 105 becomes viewable only after bar soap 100 is sufficiently used, and will preferably become visible after the bar soap's surface 103 has waste away. The message or design is embedded in layer 105 of the bar soap so that, once exposed, it dissolves with regular use of the bar.

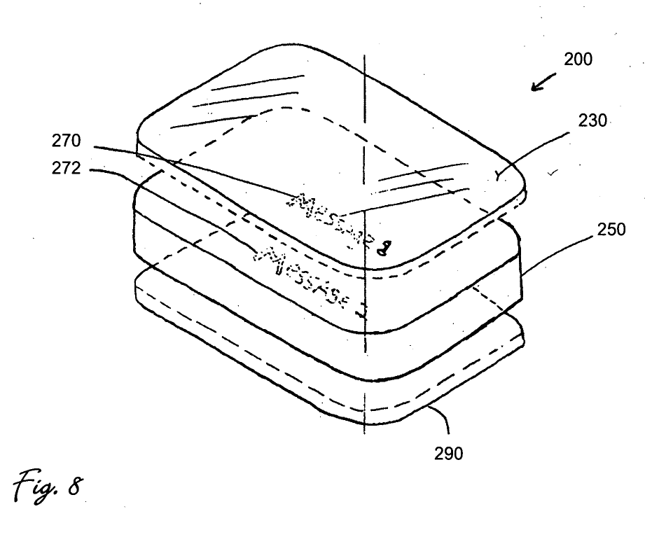

Referring to FIG. 5 there is shown a perspective view of a bar soap with two embedded messages 270 and 272 printed therein in accordance with a further aspect of the present invention is shown. Referring again to FIG. 5 in conjunction with FIGS. 6, 7 and 8, it can be seen that bar soap 200 includes an imprinted layer as indicated by reference numeral 250. As shown, layer 250 bears imprinted messages 270 and 272 which, in the figures, for illustration only, are shown as words “message 1” and “message 2”. Imprinted layer 250 is positioned within bar soap 200 such that messages 270 and 272 are located anywhere between one eighteenth and one third the distance below the bar's surface 230, allowing the messages to become viewable after the first several uses of the bar soap wastes away surface 230. Message 270 is closest to the bar soap's top surface 230 and Message 272 is closest to the bar soap's bottom surface 290. Messages 270 and 272 are intended to include any printed words, design, logo, picture, insignia, advertisement, trademark, service mark, business name, quote and so forth as desired. Although shown in the drawing for purpose of illustration only, messages 270 and 272 are not visible through bar soap 200 and only become visible as bar soap 200 is used as discussed further below.

Although illustrated with two messages 270 and 272, a plurality of messages, including progressively revealed and changing messages, non-planar indicia can be used, wherein the indicia will appear to move over time as the bar soap wears, are within the scope of the present invention. Barrier layers may be interspaced between messages thus the message would vanish and then shortly thereafter a new message would appear. In some or all of the plurality of messages they can configured to additionally stimulate multiple senses of the user including touch, smell, and state of mind produced upon discovery of the hidden visual messages. This may include a fragrance, aromatherapy, texture as well as various other sensory stimulants. Herbal or fragrance ingredients can be included to compliment the sensory message. Texture may include the use of particles of different hardness to give the feel of sand, etc. Alternatively, the texture may form ridges or lines as well as dots, which can be felt when the soap is rubbed.

Messages 270 and 272 can have several applications including, but not limited to, brand promotion, predestination applications, milestone markers, seasonal greeting, humor, etc. It also will be appreciated that the printed matter, referred to hereinafter as “message” for ease and clarity of description, can be engraved, embossed or drawn onto the soap in any desired color or pattern. The resulting messages are not viewable through bar soap 200 prior to use and only becomes apparent after the soap is used and the top and bottom surface layers, 230 and 290, respectively, of bar soap 200 have wasted away.

Referring to FIG. 10, a flow diagram illustrating one method of manufacturing bar soap 200 is shown. This involves making a soap layer 250 with imbedded messages 270 and 272 on its top and bottom surfaces respectively. This can be accomplished by pouring soft soap into a mold used to create the messages or the respective top and bottom surfaces of a hardened or semi-hardened soap layer can be imprinted with messages 270 and 272. Imprinted layer 250 is itself a bar soap, however is specifically configured to “fit” within or between additional soap bars or layers or within a larger soap mold that is scheduled for filling.

Next, a batch of soap product to form the top and bottom surface bars, 230 and 290, respectively, is prepared. Accordingly, a mold is placed onto a moving conveyor belt. The mold is designed to produce any desired configuration of soap cake, as discussed above. The mold can be a polyvinyl clamshell mold or a multi-cavity tray made from a silicone compound. The molds travel down the conveyer and trigger a conventional filling mechanism. A piston liquid filler then dispenses a small, predetermined amount of liquid hot soap into the mold to partially or half fill the mold. The mold then travels through a cooling tunnel and exits at the opposite end of the conveyor line where it is placed on a return conveyor, which returns it to the front of the line. The partially filled semi-cooled soap mold is then placed onto the conveyor for a second pass. If the imprinted layer 250 is provided on a carrier, it is first removed or pulled off the carrier. The imprinted layer 250 is placed onto the semi-cooled soap in the mold, generally by hand, and lightly rubbed down. The mold then moves on the conveyor and triggers the filling mechanism so that a remaining, predetermined amount of liquid soap is introduced into the mold, encasing layer 250. The mold once again moves through the cooling tunnel and exists at the opposite end of the line for packaging. Imprinted layer 250 is set such that the message 270 will be covered by, yet proximate to, surface 230 and message 270 will be covered by, yet proximate to, surface 290.

It will be appreciated that the above procedure produces a bar soap 200 which has two or more messages concealed within the bar. According to a preferred embodiment, messages 270 and 272 are located at approximately between one eighteenth and one-third the distance from the bars surface. Any message or design imprinted on layer 250 becomes viewable only after its nearest surface layer hag wasted away through use of the bar. Messages 270 and 272 are embedded in layer 250 of the cleansing bar so that, once exposed, they dissolve with regular use of the bar.

In yet a further embodiment of the present invention an indicia layer is comprised of a first opaque soap composition having coloration which is shaped to define an indicia and a second opaque soap composition having coloration different than the first opaque composition coloration surrounds the indicia to define an indicia layer. The indicia layer may be molded or extruded and sliced (cut) when sufficiently cooled. A top layer and a bottom layer of the second opaque soap covers the indicia layer such that the indicia is covered and hidden by the top layer and the bottom layer until the top layer and the bottom layer is sufficiently dissolved to reveal the hidden indicia.

Composition formulations for yielding cleansing bar soap 100, 200 have been omitted, as the present invention is equally well suited for use with any formulation.

Although this invention has been described with a certain degree of particularity, it is to be understood that the present disclosure has been made by way of example only and that numerous changes in the detailed construction and the combination and arrangement of parts may be resorted to without departing form the spirit and scope of the invention as hereinafter claimed.

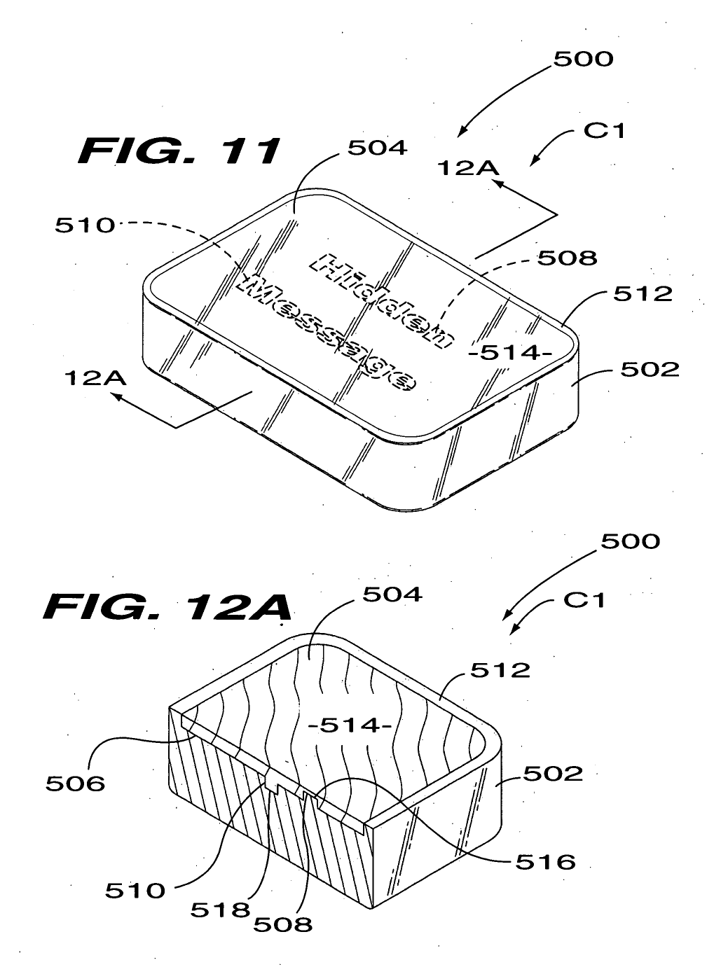

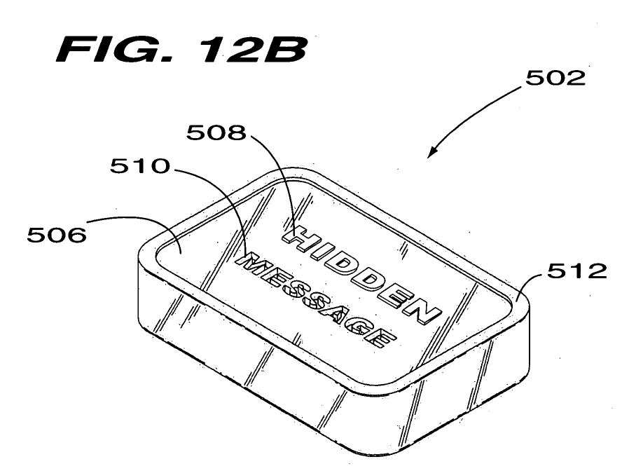

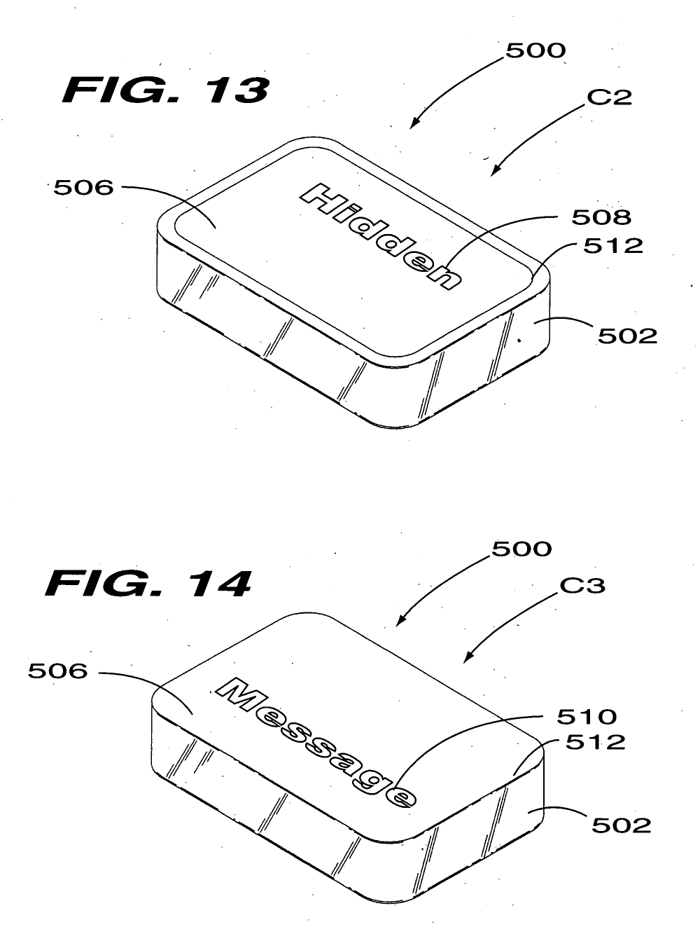

Referring to now FIGS. 11 and 12A, a second embodiment of a soap bar in accordance with the present invention (i.e., soap bar 500) is shown. The soap bar 500 includes a soap bar body 502 made from a first soap composition and a layer 504 of a second soap composition formed on the soap bar body 502 over a face 506 (shown in FIG. 12). The soap bar body 502 includes first indicia 508 that extend above the face 506 and second indicia 510 that are within the face 506. Jointly, the first indicia 508 and the second indicia 510 represent indicia that are integral with the face 506. Thus, indicia in accordance with the present invention can be above a reference face of the soap bar body, below the reference face of the soap bar body, or both. As shown, the layer 504 of the second soap composition is formed on the soap bar body 502 over the face 506 and the indicia (508, 510), such that the indicia (508, 510) are visually hidden under the layer 504 of the second soap composition. In at least one embodiment, the indicia (508, 510) being visually hidden includes the indicia being tactically hidden (e.g., not able to be felt by one's finger). While indicia as shown is integral with one face of the soap bar body 502, it is disclosed herein that indicia may be integral with two or more faces of the soap body bar 502.

The second soap composition visually contrasts the first soap composition. In one embodiment, the first soap composition is a first color and the second soap composition is a second color different than the first color. Preferably, but not necessarily, the first soap composition and the second soap composition are each opaque colors. However, other means of providing such visually contrasts are possible. For example, the first and second soap compositions can be of the same opaque color, but have fillers of different color and/or texture fillers provided therein.

Preferably, but not necessarily, as best shown in FIGS. 11, 12A and 12B, a ridge 512 extends around and above the face 506, thereby forming a recess in the soap bar body 502. The layer 504 of the second soap composition partially or fully fills the recess. At a minimum, for a given second soap composition, a thickness of the layer 504 is essentially limited to that thickness necessary to visually hide the indicia (508, 510).

Referring now to FIGS. 11-14, it can be seen that the soap bar 500 is configured with a hidden message (i.e., indicia 508, 510) that becomes revealed as the layer 504 of the second soap composition is washed away. As shown in FIGS. 11 and 12A, when the soap bar 500 is in a new or initially used condition C1 (i.e., an indicia hiding condition), the layer 504 of the second soap composition covers the indicia (508, 510) such that it is visually hidden under the layer 504 of the second soap composition. As shown in FIGS. 13 and 14, when the soap bar 500 is sufficiently used (i.e., in an indicia exposing conditions), the layer 504 of the second soap composition is worn away through use such that the indicia (508, 510) is visible (i.e., unhidden or revealed). As shown, in FIGS. 12A and 12B, the first indicia 508 extend above the face 506 and the second indicia 510 are formed within the face 506. Accordingly, the first indicia 508 becomes visible upon a first portion of a thickness of the layer 504 being washed away (i.e., first indicia exposed condition C2) and the second indicia 510 becomes visible upon a second portion of the thickness of the layer 504 being washed away (i.e., second indicia exposed condition C3). In this manner, the indicia (508, 510) are separately revealed dependent upon an amount of the layer 504 that is washed away. Indicia below the face 506 and above the face 506 are one example of dual elevation indicia for the purpose of providing sequential messaging. In other examples, a plurality of indicia can be at different heights above or below the face 506 to provide for such sequential messaging. Upon a third portion of the thickness amount of the layer 504 being washed away, the indicia (508, 510) is fully washed away. The first portion of the thickness of the layer 504 is a distance from an as-formed exterior face 514 of the layer 504 to a top as-formed face 516 of the first indicia 508. The second portion of the thickness of the layer 504 is a distance from the top as-formed face 516 of the first indicia 508 to the face 506 of the soap bar body 502. The third portion of the thickness of the layer 504 is a distance the face 506 of the soap bar body 502 to a full depth of the second indicia 510 within the face 506 of the soap bar body 502.

It is disclosed herein that the soap compositions (508, 510) can each have substantially the same rate at which they wash away under normal and expected use or a different rate at which they wash away under normal and expected use. For example, in one embodiment, the first soap composition washes away at a first rate and the second soap composition washes away at a second rate greater than the first rate. In this manner, for given use parameters, the indicia (508, 510) becomes visible in a shorter duration of time than if the layer 504 is made from a soap composition that washes away at the first rate. In one embodiment, the second soap composition is configured (e.g., wash-away rate, physical dimension, etc.) such that upon normal use, the indicia (508, 510) becomes visible after approximately five to thirty uses of the soap bar 500. A specifiable wash-away rate can be beneficial in that, for a given distance from the as-formed exterior face 514 of the layer 504 to the top as-formed face 516 of the first indicia 508 and for given use conditions, it provides a means for controlling the duration of time for at least the first indicia 508 becoming visible.

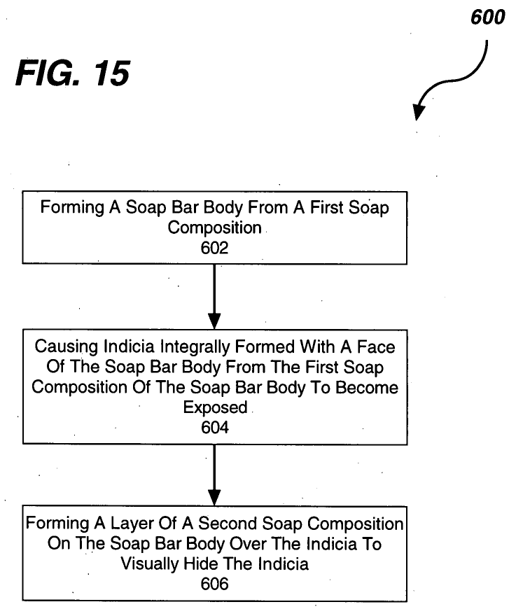

Referring now to FIG. 15, an embodiment of a method 600 for forming a soap bar in accordance with the present invention (e.g., the soap bar 500) is shown. The method 600 begins with an operation 602 for forming a soap bar body from a first soap composition. Thereafter, an operation 604 is performed for causing indicia integrally formed with a face of the soap bar body from the first soap composition of the soap bar body to become exposed. After the indicia are exposed, an operation 606 is performed for forming a layer of a second soap composition on the soap bar body over the indicia to visually hide the indicia.

The operation of exposing the indicia can result in the indicia extending above the face of the soap bar body, below the face of the soap bar body, or both. Furthermore, the operation of forming the soap bar body can include forming a recess defined by the face and a ridge extending around the face. As such, the operation for forming a layer of a second soap composition on the soap bar body over the indicia can include filling the recess with a sufficient quantity of the second soap composition to visually hide the indicia. As discussed above, the first soap composition can be of a first color and/or have a first wash-away rate and the second soap composition can be of a second color different than the first color and/or have a second wash-away rate different than the first wash-away rate.

Turning now to specific implementations of the method 600, in a first specific implementation, a soap bar body is formed in a cavity of a soap bar mold that produces a soap bar with desired shape and volume characteristics (e.g., an open face mold). A prescribed quantity of a first soap composition, which is in a heated state to allow for it to be dispensed in a flowable manner (e.g., injected, poured, etc), is deposited in the mold cavity. Upon sufficient cooling while the soap bar body is still in the mold cavity, an exposed face of the soap bar body is impressing with a stamp. The stamp includes a representation of desired indicia, thereby causing corresponding indicia to be formed integral with the exposed face of the soap bar body when the soap bar body is impressing with the stamp. Thereafter, a prescribed quantity of a second soap composition, which is in a heated state to allow for it to be dispensed in a flowable manner, is deposited in the mold cavity over the soap bar body. The prescribed quantity of the second soap composition is of a sufficient volume such the indicia and associated face of the soap bar body are covered with a layer of the second soap composition in a manner whereby the indicia are visually hidden. After adequate cooling, the finished soap bar is removed from the mold cavity.

In a second specific implementation, a soap bar body is formed in a cavity of a soap bar mold that produces a soap bar with desired shape and volume characteristics (e.g., an open face mold). A prescribed quantity of a first soap composition, which is in a heated state to allow for it to be dispensed in a flowable manner (e.g., injected, poured, etc), is deposited in the mold cavity. Upon sufficient cooling and, optionally, while the soap bar body is still in the mold cavity, an exposed face of the soap bar body is impressing with a stamp. The stamp includes a representation of desired indicia, thereby causing corresponding indicia to be formed integral with the exposed face of the soap bar body when the soap bar body is impressing with the stamp. The stamp further includes a ridge forming portion that causes a ridge to be formed in the soap bar body around the face in which the indicia are formed. Thus, the indicia are formed within a recess defined by the ridge extending around a perimeter of the face in which the indicia are formed. Thereafter, a prescribed quantity of a second soap composition, which is in a heated state to allow for it to be dispensed in a flowable manner, is deposited into the recess of the soap bar body. The prescribed quantity of the second soap composition is of a sufficient volume such that the indicia and associated face of the soap bar are covered with a layer of the second soap composition in a manner whereby the indicia are visually hidden, and such the layer of the second soap composition is level with or below a top of the ridge. After adequate cooling, the soap bar is removed from the mold cavity, if the soap bar body was still in the mold when the second soap composition was deposited.

In a third specific implementation, a soap bar body is formed in a cavity of a soap bar mold that produces a soap bar with desired shape and volume characteristics (e.g., an open face mold). A face of the mold includes a representation of desired indicia integral therewith and a recess forming portion. The representation of the desired indicia is integral with a face encompassed by the ridge forming portion. Examples of the ridge forming portion include, but are not limited to, a protruding face of the mold having the indicia representation integral therewith, a groove extending around a face of the mold having the indicia representation integral therewith, and the like. A prescribed quantity of a first soap composition, which is in a heated state to allow for it to be dispensed in a flowable manner (e.g., injected, poured, etc), is deposited in the mold cavity. Upon sufficient cooling, depending on the specific mold configuration, the soap bar body is either extracted from the mold cavity to expose indicia formed in a face of the soap bar body or a portion of the soap bar mold is displaced to expose the indicia formed in a face of the soap bar body. Thereafter, a prescribed quantity of a second soap composition, which is in a heated state to allow for it to be dispensed in a flowable manner, is deposited into the recess of the soap bar body. The prescribed quantity of the second soap composition is of a sufficient volume such that at least a portion of the recess is filled with the second soap composition, thereby forming a layer of the second soap composition over the indicia and a face of the soap bar body that the indicia are integral with. The finished soap bar is removed from the mold cavity, if the soap bar body was still in the mold when the second soap composition was deposited.

Although illustrated with first and second indicia (508, 510), a soap bar in accordance with the present invention may include more than two hidden indicia or less than two hidden indicia. Furthermore such hidden indicia may include indicia that is,progressively revealed, that changes with use of the soap bar, and/or that is non-planar such that the indicia will appear to move over time as the soap bar wears. It is disclosed herein that barrier layers may be interspaced between indicia thus the indicia will vanish and then shortly thereafter, new indicia will appear. Soap bars in accordance with the present invention can be further configured to stimulate multiple senses of the user including touch, smell, and state of mind produced upon discovery of the hidden indicia. This may include a fragrance, aromatherapy, texture as well as various other sensory stimulants. Herbal or fragrance ingredients can be included in the soap composition(s) to compliment the sensory message. Texture may include the use of particles of different hardness to give the feel of sand, etc. Alternatively, the texture may form ridges or lines as well as dots that can be felt when the soap is rubbed.

It is disclosed herein that a soap composition used in fabricating a soap bar in accordance with the present invention is not unnecessarily limited to a particular formulation. For example, in one embodiment, soap compositions used in fabricating a soap bar in accordance with the present invention are each made from metallic salt (e.g., Sodium, Potassium or the like) of fatty acids, from pure synthetic detergents, or combination thereof. Furthermore, a soap bar in accordance with the present invention can be made in any desired size and/or shape.

A variety of essential oils may be used in making a soap bar in accordance with the present invention. Suitable essential oils for use in the present lotion composition include, but are not limited to, abies sibirica oil, amyris balsamifera oil, anise (illicium verum) oil, balm mint (melissa officinalis) oil, basil (ocimum basilicum) oil, bay (pimenta acris) oil, bee balm (monarda didyma) oil, bergamot (citrus aurantium bergamia) oil, birch (betula aba) oil, bitter orange (citrus aurantium amara) oil, cabbage rose (rosa centifolia) oil, calendula officinalis oil, california nutmeg (torreya californica) oil, camellia sinensis oil, capsicum frutescers oleoresin, caraway (carum carvi) oil, cardamon (elettaria cardamomum) oil, cedarwood (cedrus atlantica) oil, chamaecyparis obtusa oil, chamomile (anthemis nobilis) oil, cinnamon (cinnamomum cassia) oil, citronella (cymbopogon nardus) oil, clary (salvia sclarea) oil, clove (eugenia caryophyllus) oil, cloveleaf (eugenia caryophyllus) oil, coriander (coriandrum sativum) oil, coriander (coriandrum sativum) seed oil, cyperus esculentus oil, cypress (cupressus sempervirens) oil, eucalyptus citriodora oil, eucalyptus globulus oil, fennel (foeniculum vulgare) oil, gardenia florida oil, geranium maculatum oil, ginger (zingiber officinale) oil, gold of pleasure (camelina sativa) oil, grapefruit (citrus grandis) oil, hops (humulus lupulus) oil, hypericum perforatum oil, hyptis suaveolens oil, indigo bush (dalea spinosa) oil, jasmine (jasminum officinale) oil, juniperus communis oil, juniperus virginiana oil, labdanum (cistus labdaniferus) oil, laurel (laurus nobilis) oil, lavandin (lavandula hybrida) oil, lavender (lavandula angustifolia) oil, lemon (citrus medica limonum) oil, lemongrass (cymbopogon schoenanthus) oil, leptospermum scoparium oil, lime (citrus aurantifolia) oil, linden (tilia cordata) oil, litsea cubeba oil, lovage (levisticum officinale) oil, mandarin orange (citrus nobilis) oil, massoy bark oil, matricaria (chamomilla recutita) oil, moroccan chamomile oil, musk rose (rosa moschata) oil, myrrh (commiphora myrrha) oil, myrtle (myrtus communis) oil, norway spruce (picea excelsa) oil, nutmeg (myristica fragrans) oil, olax dissitiflora oil, olibanum oil, opoponax oil, orange (citrus aurantium dulcis) flower oil, orange (citrus aurantium dulcis) oil, palmarosa (cymbopogon martini) oil, parsley (carum petroselinum) seed oil, passionflower (passiflora incarnata) oil, patchouli (pogcstemon cablin) oil, pelargonium graveolens oil, pennyroyal (mentha pulegium) oil, peppermint (mentha piperita) oil, pine (pinus palustris) oil, pine (pinus palustris) tar oil, pine (pinus pinea) kernel oil, pine (pinus pumiho) oil, pine (pinus sylvestris) cone oil, rosemary (rosmarinus officinalis) oil, rose oil, rosewood (aniba rosseodora) oil, rue (ruts graveolens) oil, sage (salvia officinalis) oil, sambucus nigra oil, sandalwood (santalum album) oil, sandarac (callitris quadrivalvis) gum, sassafras officinale oil, sisymbrium oil, spearmint (mentha viridis) oil, sweet marjoram (origanum majorana) oil, sweet violet (viola odorata) oil, tar oil, thuja occidentalis oil, thyme (thymus vulgaris) oil, vetiveria zizanoides oil, wild mint (mentha arvensis) oil, ximenia americana oil, yarrow (achillea millefolium) oil, ylang yang (cananga odorata) oil, or any combinations thereof.

Examples of aromatherapy include Lavendin, a botanical variety of lavender, which is used for promoting relaxation and calming effect to the bather and Chamomile which is used for promoting calm and relaxation to the bather.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method of forming a soap bar, comprising:
forming a soap bar body from a first soap composition, wherein the soap bar body has indicia integral with a face thereof; and
forming a layer of a second soap composition on the soap bar body over said indicia such that said indicia are visually hidden under the layer of second soap composition, wherein the second soap composition visually contrasts the first soap composition.

2. The method of claim 1 wherein:
the first soap composition is a soap composition of a first color; and
the second soap composition is a soap composition of a second color different than the first color.

3. The method of claim 2 wherein:
a first portion of said indicia extends above-the face therefrom; and
a second portion of said indicia are within the face.

4. The method of claim 2 wherein, for a given second soap composition, a thickness of the layer of the second soap composition is essentially limited to that thickness necessary to visually hide said indicia.

5. The method of claim 2 wherein:
the first soap composition washes away at a first rate;
the second soap composition washes away at a second rate; and
the second rate is substantially the same as the first rate.

6. The method of claim 1 wherein forming the soap bar body includes:
partially filling a soap bar mold with a prescribed volume of the first soap composition; and
impressing the face of the soap bar body with a stamp having a representation of said indicia integral with a surface thereof that contacts the face of the soap bar body.

7. The method of claim 6 wherein:
at least a portion of the representation of said indicia extends above the surface of the stamp that contacts the face of the soap bar body.

8. The method of claim 7 wherein:
the surface of the stamp having the representation of said indicia includes ridge forming portion that causes a ridge to be formed around a perimeter of the face;
at least a portion of the representation of said indicia extends above the ridge forming portion whereby forming said indicia in the soap bar body causes a ridge to be formed around a perimeter of the face.

9. The method of claim 8 wherein, for a given second soap composition, a thickness of the layer of the second soap composition is essentially limited to that thickness necessary to visually hide said indicia.

10. The method of claim 8 wherein:
the first soap composition washes away at a first rate;
the second soap composition washes away at a second rate; and
the second rate is substantially the same as the first rate.

11. The method of claim 8 wherein:
a first portion of said indicia extends above the face therefrom; and
a second portion of said indicia are within the face.

12. The method of claim 1 wherein:
forming the soap bar body includes forming a ridge around the face thereby producing a recess in the soap bar body and forming said indicia integral with the face of the soap bar within the recess; and
forming the layer of the second soap composition includes at least partially filling the recess.

13. The method of claim 12 wherein:
the first soap composition is a soap composition of a first color; and
the second soap composition is a soap composition of a second color different than the first color.

14. The method of claim 13 wherein:
at least a portion of said indicia are formed within the face.

15. The method of claim 14 wherein:
a first portion of said indicia extends above the face therefrom; and
a second portion of said indicia are within the face.

16. The method of claim 14 wherein:
the first soap composition washes away at a first rate;
the second soap composition washes away at a second rate; and
the second rate is substantially the same as the first rate.

17. A soap bar, comprising:
a soap bar body made from a first soap composition, wherein the soap bar body includes indicia integral with a face thereof, wherein said indicia defined by the first soap composition and wherein the first soap composition is a soap composition of a first color; and
a layer of a second soap composition formed on the soap bar body over the face and said indicia such that said indicia are visually hidden under the layer of the second soap composition, wherein the second soap composition is a soap composition of a second color different than the first color.

18. The soap bar of claim 17 wherein, for a given second soap composition, a thickness of the layer of the second soap composition is essentially limited to that thickness necessary to visually hide said indicia.

19. The soap bar of claim 18 wherein, for a given second soap composition, a thickness of the layer of the second soap composition is essentially limited to that thickness necessary to visually hide said indicia.

20. The soap bar of claim 19 wherein:
the soap bar body includes a ridge defining a perimeter of the face such that the face and the ridge jointly define a recess in the soap bar body;
said indicia are at least one of within the face and extending above the face therefrom;
said indicia are made from first soap composition; and
the layer of the second soap composition at least partially fills the recess.

21. The soap bar of claim 20 wherein:
a first portion of said indicia extends above the face therefrom; and
a second portion of said indicia are within the face.

22. The soap bar of claim 21 wherein:
the first soap composition washes away at a first rate;
the second soap composition washes away at a second rate; and
the second rate is substantially the same as the first rate.

23. A soap bar, comprising:
a soap bar body made from a first soap composition, wherein the soap bar body includes a ridge defining a perimeter of the face such that the face and the ridge jointly define a recess in the soap bar body and wherein the soap bar body includes indicia that are at least one of within the face and extending above the face therefrom, wherein said indicia are made from the first soap composition, wherein the first soap composition is of a first color, and wherein the first soap composition washes away at a first rate; and
a layer of a second soap composition within the recess and covering said indicia such that said indicia are visually hidden under the layer of the second soap composition, wherein the second soap composition is of a second color different than the first color first color and wherein the second soap composition washes away at a second rate substantially the same as the first rate.
